(19) United States
(12) Patent Application Publication
(10) Pub. No.: US 2025/0385826 A1
(43) Pub. Date: Dec. 18, 2025

(54) COMMUNICATION DEVICE, CONTROL METHOD, AND COMPUTER PROGRAM PRODUCT

(71) Applicant: KABUSHIKI KAISHA TOSHIBA, Tokyo (JP)

(72) Inventors: Masahiko SUGIMOTO, Hiratsuka, Kanagawa (JP); Kensei KAWABATA, Musashino, Tokyo (JP); Toshinori DOI, Suginami, Tokyo (JP)

(73) Assignee: KABUSHIKI KAISHA TOSHIBA, Tokyo (JP)

(21) Appl. No.: 18/877,357

(22) PCT Filed: Jun. 28, 2023
(86) PCT No.: PCT/JP2023/023908

§ 371 Date: Dec. 20, 2024

(30) Foreign Application Priority Data
Jul. 5, 2022 (JP) 2022-108333

(51) Int. Cl. H04L 27/26; H04J 11/00; H04L 5/00

(52) U.S. Cl. CPC H04L 27/265; H04J 11/0073; H04J 11/0076; H04L 5/0051

(57) ABSTRACT

A communication device according to an embodiment includes a memory and one or more processors coupled to the memory. The one or more processors are configured to: receive an OFDM signal and convert the OFDM signal into a time-axis waveform signal of a baseband; extract a part of the time-axis waveform signal, and calculate a correlation value between the extracted signal and a known signal; execute FFT on the time-axis waveform signal; extract a part of a frequency-axis waveform signal on which the FFT is executed, and calculate a degree of similarity between the extracted signal and a known signal; and estimate a switching timing between uplink communication and downlink communication in the communication device based on a calculation result of the similarity degree.

### FIELD

Embodiments described herein relate generally to a communication device, a control method, and a program.

### BACKGROUND

A distributed antenna system (DAS) is known as one form of a wireless communication system. In the distributed antenna system, communication is executed by time division duplex (TDD) in which downlink (DL) communication for transmission from a base station to a terminal and uplink (UL) communication for transmission from the terminal to the base station are switched in every predetermined period. Such a distributed antenna system needs to detect a DL period and a UL period of a radio signal to appropriately switch the DL period and the UL period.

A conventional communication device has determined presence or absence of a DL radio signal from a base station with power detection, and has switched DL and UL according to a result of the determination. In a communication device in which a plurality of mobile carriers share one DAS, the plurality of mobile carriers interfere with one another when DL/UL switching timings of the plurality of mobile carriers deviate. Therefore, the communication device has detected a first symbol of a DL radio frame to detect the deviation of the DL/UL switching timing among the carriers.

### CITATION LIST

### Patent Literature

Patent Literature 1: JP 2020-053769 A
Patent Literature 2: JP 2020-504568 A

### SUMMARY OF THE INVENTION

### Problem to be Solved by the Invention

However, in a radio signal in 5G (5th Generation) or the like, there is a case in which electric power (signal) is absent in a first symbol of a radio frame. For that reason, it is difficult for the communication device to accurately detect DL/UL switching timing with a power detection method or a first symbol detection method of the related art.

Therefore, an object of embodiments of the present invention is to provide a communication device, a control method, and a program, which can detect DL/UL switching timing even when electric power (signal) is absent in a first symbol of a radio frame in a TDD scheme in which DL communication and UL communication are switched in every predetermined period.

### Means for Solving Problem

A communication device according to one embodiment functions, in a distributed antenna system including a master station device connected to a base station and one or more slave station devices relaying signals between the master station device and one or more terminal devices communicating with the base station, as the master station device or the slave station device, and receives an OFDM (Orthogonal Frequency Division Multiplexing) signal transmitted in a time division multiplexing scheme, the communication device including a signal reception module, a time waveform calculation module, an FFT module, a frequency waveform calculation module, and a switching timing estimation module. The signal reception module is configured to receive the OFDM signal and convert the OFDM signal into a time-axis waveform signal of a baseband. The time waveform calculation module is configured to extract a part of the time-axis waveform signal, which is an output of the signal reception module, and calculate a correlation value between the extracted signal and a known signal. The FFT module is configured to execute FFT (Fast Fourier Transform) on the time-axis waveform signal, which is the output of the signal reception module. The frequency waveform calculation module is configured to extract a part of a frequency-axis waveform signal, which is an output of the FFT module, and calculate a degree of similarity between the extracted signal and a known signal. The switching timing estimation module is configured to estimate a switching timing between uplink communication and downlink communication in the communication device based on a calculation result of the frequency waveform calculation module.

### BRIEF DESCRIPTION OF DRAWINGS

FIG. 1 is a diagram illustrating an example of an overview of a distributed antenna system in a first embodiment.

FIG. 2 is a diagram illustrating an example of a data configuration of a radio frame.

FIG. 3 is a diagram illustrating an example of an arrangement pattern of SSBs in a radio frame.

FIG. 4 is a diagram illustrating an example of a DL/UL configuration and an SSB arrangement of a TDD scheme.

FIG. 5 is a diagram illustrating an example of a functional configuration of a master station device in the first embodiment.

FIG. 6 is a diagram illustrating an example of a functional configuration of a control unit in the first embodiment.

FIG. 7 is a diagram illustrating an example of a functional configuration of a switching timing generation module in the first embodiment.

FIG. 8 is a diagram illustrating an example of a functional configuration of a PSS detection module according to the first embodiment.

FIG. 9 is a diagram illustrating an example of a functional configuration of an SSS detection module according to the first embodiment.

FIG. 10 is a diagram illustrating an example of a functional configuration of a DMRS detection module according to the first embodiment.

FIG. 11 is a diagram illustrating an example of a constellation in the case in which phase rotation is absent.

FIG. 12 is a diagram illustrating an example of an I-axis signal in the case in which phase rotation is absent.

FIG. 13 is a diagram illustrating an example of a data determination result in the case in which phase rotation is absent.

FIG. 14 is a flowchart illustrating an example of TDD detection processing in the first embodiment.

FIG. 15 is a flowchart illustrating an example of time waveform processing according to the first embodiment.

FIG. 16 is a flowchart illustrating an example of FFT processing according to the first embodiment.

FIG. 17 is a flowchart illustrating an example of frequency waveform processing according to the first embodiment.

FIG. 18 is a flowchart illustrating an example of SSS detection processing according to the first embodiment.

FIG. 19 is a flowchart illustrating an example of DMRS detection processing according to the first embodiment.

FIG. 20 is a flowchart illustrating an example of switching timing estimation processing according to the first embodiment.

FIG. 21 is a diagram illustrating an example of a constellation in the case in which a CPE is present.

FIG. 22 is a diagram illustrating an example of an I-axis signal in the case in which a CPE is present.

FIG. 23 is a diagram illustrating an example of a data determination result in the case in which a CPE is present.

FIG. 24 is a diagram illustrating an example of a functional configuration of an SSS detection module according to a first modification.

FIG. 25 is a diagram illustrating an example of a functional configuration of a DMRS detection module according to the first modification.

FIG. 26 is a diagram illustrating an example of a constellation in the case in which phase rotation is present.

FIG. 27 is a diagram illustrating an example of an I-axis signal in the case in which phase rotation is present.

FIG. 28 is a diagram illustrating an example of a data determination result in the case in which phase rotation is present.

FIG. 29 is a diagram illustrating an example of a functional configuration of a switching timing generation module in a second embodiment.

FIG. 30 is a diagram illustrating an example of a functional configuration of an SSS detection module according to the second embodiment.

FIG. 31 is a diagram illustrating an example of a functional configuration of a DMRS detection module according to the second embodiment.

FIG. 32 is a diagram illustrating an example of a differential determination result in the case in which phase rotation is absent.

FIG. 33 is a diagram illustrating an example of a differential determination result in the case in which a CPE is present.

FIG. 34 is a diagram illustrating an example of a differential determination result in the case in which phase rotation is present.

### DETAILED DESCRIPTION

A communication device, a control method, and a program will be described in detail below with reference to the accompanying drawings. Note that, in the following explanation of embodiments and modifications, portions denoted by the same reference numerals have substantially the same functions, and explanation of overlapping portions is omitted as appropriate.

### First Embodiment

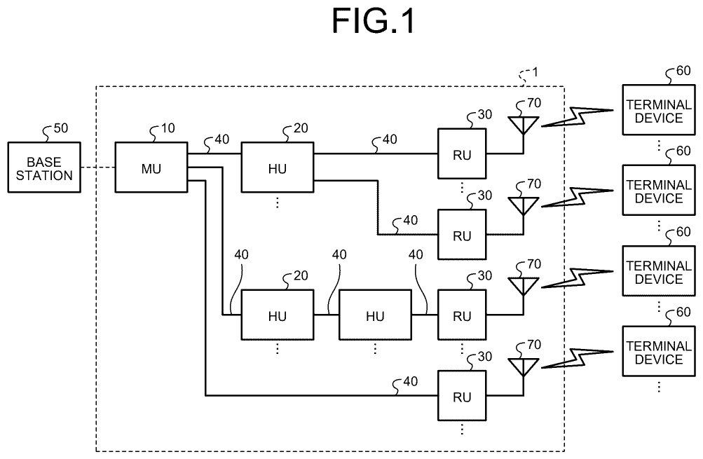

FIG. 1 is a diagram illustrating an example of an overview of a distributed antenna system 1 in a first embodiment. The distributed antenna system 1 includes a master station device 10 (MU), a relay device 20 (HU), a slave station device 30 (RU), and a transmission path 40 that connects these devices. More specifically, the distributed antenna system 1 includes the master station device 10 connected to a base station 50 and one or more slave station devices 30 that relay signals between a terminal device 60, which communicates with the base station 50, and the master station device 10.

The master station device 10 is connected to a plurality of slave station devices 30 on the inside of the distributed antenna system 1. As illustrated in FIG. 1, the plurality of slave station devices 30 may be connected to the master station device 10 via the relay device 20 or the plurality of slave station devices 30 may be directly connected the master station device 10. Further, as illustrated in FIG. 1, the relay device 20 may be cascade-connected to the master station device 10.

The master station device 10 is connected to the base station 50 by a coaxial cable and transmits and receives radio signals to and from the base station 50. Here, the radio signals are signals in a wireless communication band transmitted to the terminal device 60. The master station device 10 relays a radio signal received from the base station 50 to the relay device 20 or the slave station device 30. In addition, the master station device 10 relays a radio signal received from the relay device 20 or the slave station device 30 to the base station 50.

The slave station device 30 is connected to an antenna 70 for wireless communication with the terminal device 60 by a wired cable and transmits and receives radio signals to and from the terminal device 60 via the antenna 70. The slave station device 30 relays a radio signal received from the terminal device 60 to the master station device 10 or the relay device 20. Further, the slave station device 30 relays a radio signal received from the master station device 10 or the relay device 20 to the terminal device 60.

With the distributed antenna system 1 having such a configuration, it is possible to connect a wireless terminal, to which a radio wave does not directly reach, and the base station 50 and it is possible to expand a communicable range of the mobile communication network covered by the base station 50. For example, the distributed antenna system 1 is applicable to a mobile communication network such as 5G.

On the other hand, in the mobile communication of the related art, there is a TDD (Time Division Duplex) scheme in which uplink communication and downlink communication are performed while being switched in every predetermined period. Therefore, when the distributed antenna system 1 is applied to the mobile communication network, the distributed antenna system 1 needs to detect this switching and appropriately switch DL processing and UL processing. For this reason, in order to expand the communicable range of the mobile communication network without deteriorating communication quality, it is necessary to accurately detect the switching between the uplink communication and the downlink communication.

In a radio signal in 4G or the like of the related art, presence or absence of a DL signal from the base station 50 is determined by power detection and DL/UL is switched according to a result of the determination. In a communication device in which a plurality of mobile carriers share one DAS, since the plurality of mobile carriers interfere with one another when DL/UL switching timings of the plurality of mobile carriers deviate. Therefore, the communication device has detected a first symbol of a DL radio frame and detected the shift of the DL/UL switching timing among the carriers.

However, in a radio signal of 5G or the like, there is a case in which electric power (a signal) is absent in a first symbol of a radio frame. For that reason, it is difficult for the master station device 10 to accurately detect DL/UL switching timing with the power detection method or the method of detecting the first symbol of the related art.

In the distributed antenna system 1 including the master station device 10 connected to the base station 50 and the one or more slave station devices 30 that relay signals between the terminal device 60, which communicates with the base station 50, and the master station device 10, the master station device 10 is a communication device that functions as the master station device 10 or the slave station device 30 and receives an orthogonal frequency division multiplexing (OFDM) signal transmitted by a time division multiplexing scheme. The master station device 10 receives a radio frame including a synchronization signal block (SS/PBCH block (SSB)) in the distributed antenna system 1 the TDD scheme in which the DL communication and the UL communication are switched in every predetermined period. The SSB includes a primary synchronization signal (PSS), a secondary synchronization signal (SSS), and a physical broadcast channel (PBCH). The master station device 10 detects the SSB from the received radio frame and decodes the SSB to grasp at which position in the radio frame the received SSB is arranged.

Then, the master station device 10 estimates DL/UL switching timing based on the position of the SSB in the radio frame and a DL/UL pattern of the TDD scheme. Accordingly, the master station device 10 can estimate the DL/UL switching timing even when electric power (a signal) is absent in a first symbol of a radio frame such as a 5G radio signal.

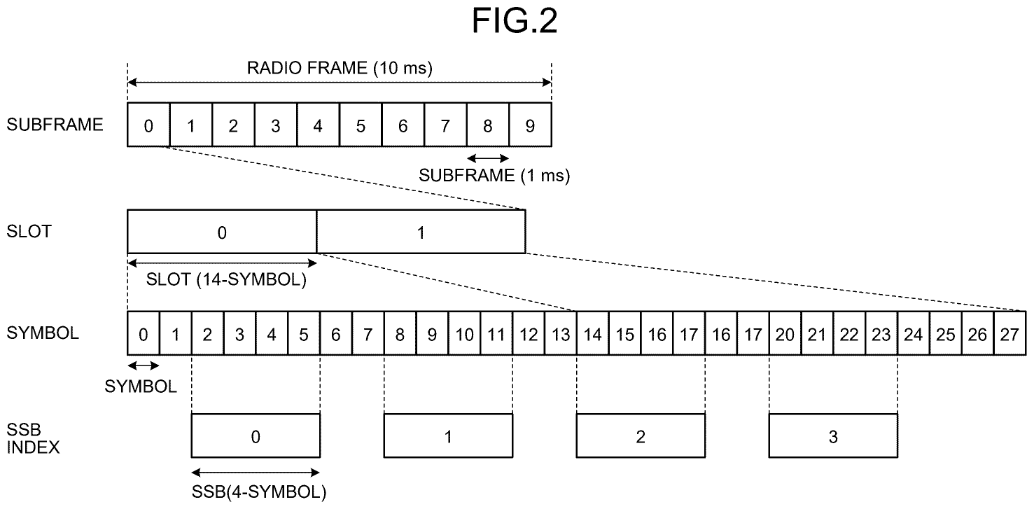

FIG. 2 is a diagram illustrating an example of a data configuration of a radio frame. FIG. 2 illustrates an example of a 5G radio frame. 1 frame is transmitted in 10 ms. One frame is composed of 10 subframes transmitted in 1 ms. Here, in 5G, a plurality of subcarrier frequency intervals are supported, and the length of one symbol is also different because of a difference among the subcarrier frequency intervals. For this reason, a concept of a slot is incorporated into a radio frame, the number of symbols per one subframe is divided into a plurality of slots, and the difference in one symbol length due to the difference among the subcarrier frequency intervals is absorbed by the number of slots per subframe. One slot has fourteen symbols regardless of a subcarrier frequency interval. FIG. 2 illustrates a case in which the subcarrier frequency interval is 30 kHz. One subframe has two slots and is composed of twenty-eight symbols. As illustrated in FIG. 2, the SSB is arranged at a specific position of the radio frame.

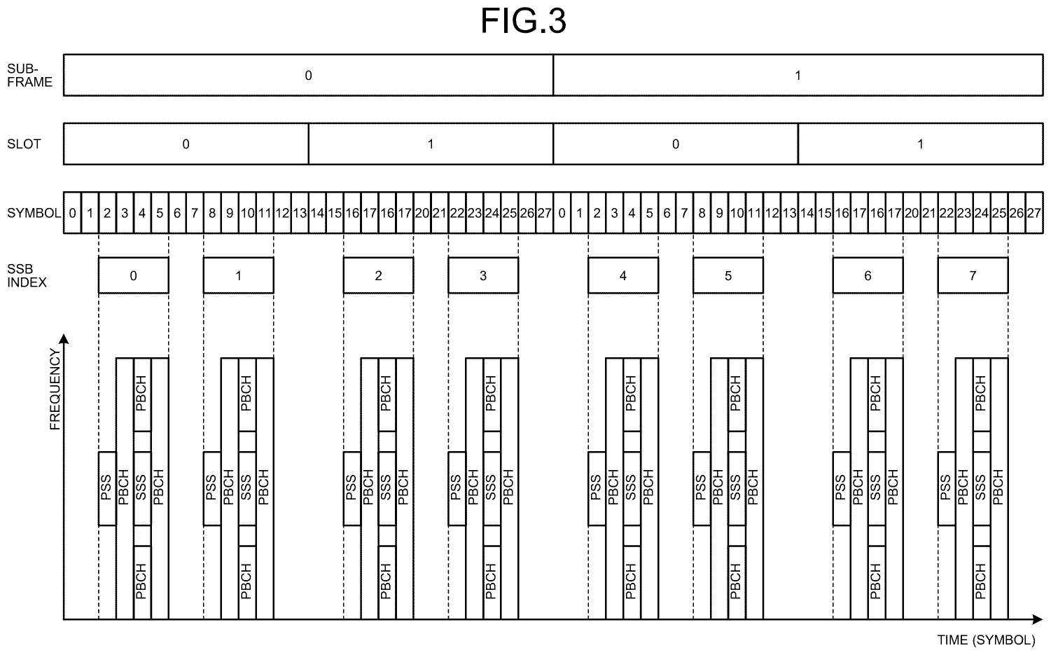

FIG. 3 is a diagram illustrating an example of an arrangement pattern of SSBs in the radio frame. The SSB is composed of four symbols. The SSB includes two synchronization signals of PSS and SSS and a PBCH signal. The PBCH signal has a DMRS (DeModulation of Reference Signal) for PBCH signal that is a reference signal for decoding the PBCH signal. An SSB index number is allocated to each of positions of the SSB in the radio frame. For example, in the operation in Japan, values of 0 to 7 are allocated as illustrated in FIG. 2. Since it is up to a carrier at which position the SSB is arranged, it is necessary to specify at which position the SSB is arranged after the SSB is detected.

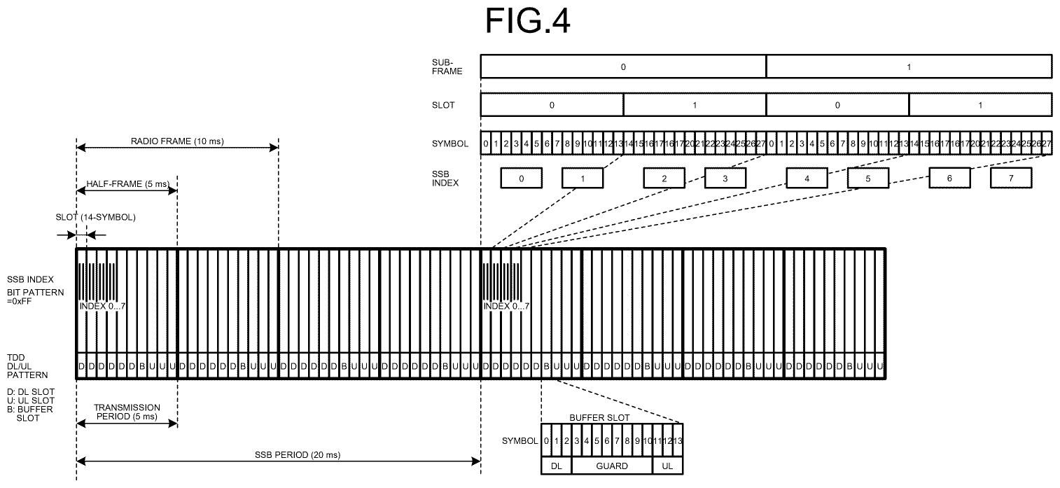

FIG. 4 is a diagram illustrating an example of a DL/UL configuration and an SSB arrangement of the TDD scheme. The SSB illustrated in FIG. 4 indicates a case in which a subcarrier frequency interval is 30 kHz, an SSB period is 20 ms, and a transmission period is 5 ms. The transmission period includes ten slots, DL is allocated to first six slots, UL is allocated to last three slots, and buffer slots are allocated between the DL slots and the UL slots. As explained above, the number of consecutive DL slots and the number of consecutive UL slots within the transmission period are set in advance. Consecutive DL symbols, consecutive UL symbols, and blank symbols functioning as guards between the DL symbols and the UL symbols are also allocated to the buffer slots. Note that the SSB illustrated in FIG. 4 indicates a configuration in which three symbols are allocated as the DL symbols and the UP symbols and eight symbols are allocated as the guards.

From the above, if an index number of the SSB arranged at a specific position of a radio frame can be detected, the master station device 10 can estimate at which position in the transmission period the SSB is arranged. Further, if DL/UL configuration information of the TDD scheme is known, the master station device 10 can estimate DL/UL switching timing within the transmission period according to a relative relation from the arrangement position of the SSB.

Note that, in the following explanation, a direction of communication from the base station 50 toward the terminal device 60 is represented as a downlink direction (downlink) and a direction opposite to the direction is represented as an uplink direction (uplink). Correspondingly, a signal transmitted in the downlink direction is referred to as “DL signal” and a signal transmitted in the uplink direction is referred to as “UL signal”.

Further, a downlink signal transmitted in a frame mode is referred to as “downlink frame” and an uplink signal transmitted in a frame mode is referred to as “uplink frame”. Concerning a certain device, an uplink direction side is sometimes referred to as “upper” and a downlink direction side is sometimes referred to as “lower”. Correspondingly, a device connected to an upper side of the certain device is sometimes referred to as “upper device” and a device connected to a lower side is sometimes referred to as “lower device”.

For example, the master station device 10 is an upper device of the relay device 20 and the slave station device 30, and the relay device 20 is an upper device of the slave station device 30. On the other hand, conversely, the relay device 20 and the slave station device 30 are lower devices of the master station device 10, and the slave station device 30 is a lower device of the master station device 10 and the relay device 20.

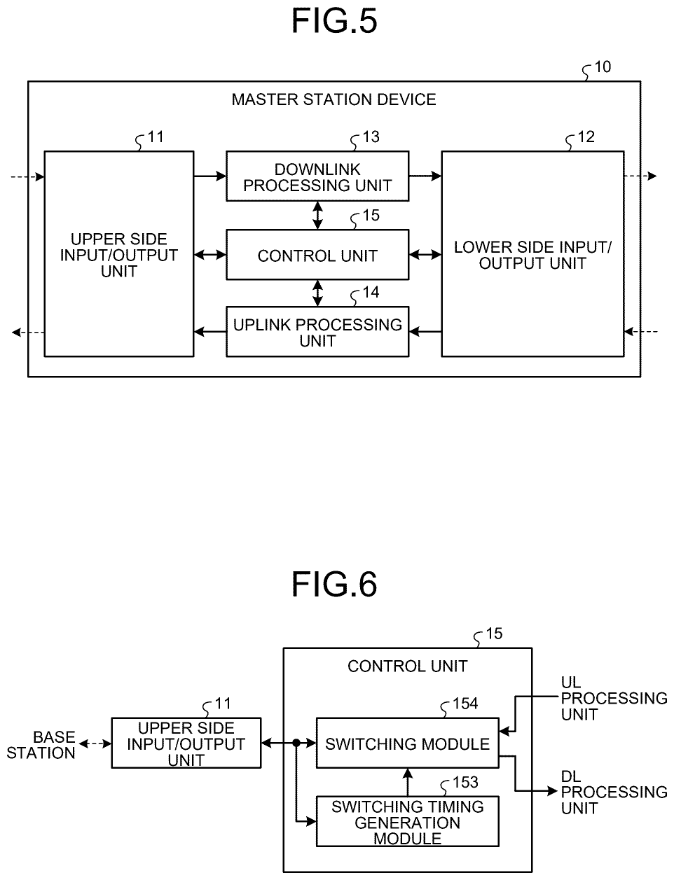

FIG. 5 is a diagram illustrating an example of a functional configuration of the master station device 10 in the first embodiment. The master station device 10 includes a CPU (Central Processing Unit), a memory, and an auxiliary storage device connected by a bus and executes a program. The master station device 10 includes an upper side input/output unit 11, a lower side input/output unit 12, a downlink processing unit 13, an uplink processing unit 14, and a control unit 15 according to the execution of the program. All or a part of the functions of the master station device 10 may be implemented by using hardware such as an ASIC (Application Specific Integrated Circuit), a PLD (Programmable Logic Device), or an FPGA (Field Programmable Gate Array). The program may be recorded in a computer-readable recording medium. The computer-readable recording medium is, for example, a portable medium such as a flexible disk, a magneto-optical disk, a ROM, or a CD-ROM or a storage device such as a hard disk incorporated in a computer system. The program may be transmitted via a telecommunication line.

The upper side input/output unit 11 is a communication interface that inputs and outputs radio signals to and from an upper device of the master station device 10. Specifically, the upper side input/output unit 11 is a communication interface that inputs and outputs radio signals to and from the base station 50 via a coaxial cable. The upper side input/output unit 11 outputs a DL signal received from the base station 50 to the downlink processing unit 13 and outputs a UL signal input from the uplink processing unit 14 to the base station 50.

The lower side input/output unit 12 is a communication interface that inputs and outputs radio signals to and from a lower device of the master station device 10. Specifically, the lower side input/output unit 12 is a communication interface that inputs and outputs radio signals to and from the slave station device 30. The lower side input/output unit 12 outputs a UL signal received from the slave station device 30 to the uplink processing unit 14 and outputs a DL signal input from the downlink processing unit 13 to the slave station device 30.

The downlink processing unit 13 executes processing (hereinafter referred to as “DL processing”) of outputting a DL signal received by the master station device 10 from the upper device to the lower device. Specifically, the DL processing of the master station device 10 includes AD (Analog to Digital) conversion processing on a DL signal received from the base station 50 and mapping processing of associating a digital signal with a frame. The downlink processing unit 13 outputs a downlink frame associated with the DL signal in the DL processing to the lower side input/output unit 12.

The uplink processing unit 14 executes processing (hereinafter referred to as “UL processing”) of outputting a UL signal received by the master station device 10 from the lower device to the upper device. Specifically, the UL processing of the master station device 10 includes de-mapping processing of acquiring a UL signal from an uplink frame received from the relay device 20 or the slave station device 30 and DA (Digital to Analog) conversion processing on the UL signal acquired by the de-mapping processing. The uplink processing unit 14 outputs the UL signal converted into an analog signal in the UL processing to the upper side input/output unit 11.

The control unit 15 has a function of switching between uplink communication and downlink communication in the master station device 10. Specifically, the control unit 15 has a function of detecting switching of uplink communication and downlink communication and switches DL processing and UL processing (transmission operation) at timing when the switching of the uplink communication and the downlink communication is detected.

FIG. 6 is a diagram illustrating an example of a functional configuration of the control unit 15 in the first embodiment. The control unit 15 includes a switching timing generation module 153 and a switching module 154.

The switching timing generation module 153 estimates a UL period or a DL period and provides notification of switching timing for UL processing and DL processing. Specifically, the switching timing generation module 153 provides notification of start timing for the estimated UL period or DL period. Notification of the start timing may be provided as start time of the UL period or the DL period or may be provided as an elapsed time from the present time. The notification of the start timing may be providing notification of arrival of the start timing.

The switching module 154 switches between the UL processing and the DL processing at the switching timing notification of which is provided from the switching timing generation module 153.

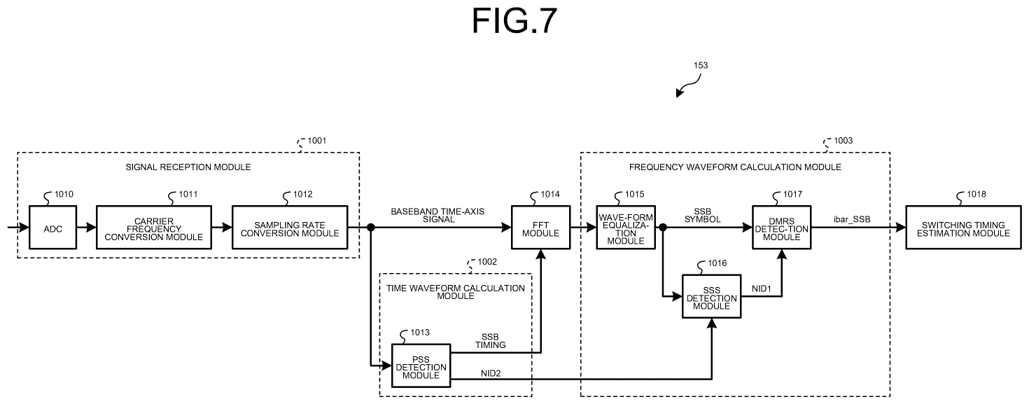

FIG. 7 is a diagram illustrating an example of a functional configuration of the switching timing generation module 153 in the first embodiment. The switching timing generation module 153 includes a signal reception module 1001, a time waveform calculation module 1002, an FFT (Fast Fourier Transform) module 1014, and a frequency waveform calculation module 1003.

The signal reception module 1001 includes an ADC module 1010, a carrier frequency conversion module 1011, and a sampling rate conversion module 1012. The signal reception module 1001 receives an OFDM signal and converts the OFDM signal into a time-axis waveform signal of a baseband. More specifically, the signal reception module 1001 receives a radio frame including SSB. That is, the signal reception module 1001 receives SSB including PSS, SSS, and PBCH including DMRS.

The ADC module 1010 converts an input analog signal into a digital signal and outputs the digital signal to the carrier frequency conversion module 1011. The carrier frequency conversion module 1011 frequency-down-converts an input digital signal, converts the digital signal into a baseband signal, and outputs the baseband signal to the sampling rate conversion module 1012. The sampling rate conversion module 1012 generates a baseband time-axis waveform signal, which is a time-axis waveform signal of a baseband, by converting a sampling rate of the input baseband signal. Then, the sampling rate conversion module 1012 outputs the baseband time-axis waveform signal to a PSS detection module 1013 and the FFT module 1014.

The time waveform calculation module 1002 includes a PSS detection module 1013. The time waveform calculation module 1002 extracts a part of the time-axis waveform signal of the baseband, which is the output of the signal reception module 1001, and calculates a correlation value between the extracted signal and a known signal.

The PSS detection module 1013 detects a PSS signal included in the time-axis waveform signal. More specifically, the PSS detection module 1013 detects, from the baseband signal after the sampling rate conversion, a PSS signal arranged at the beginning of the SSB and outputs the detected timing to the FFT module 1014 as SSB timing. The PSS detection module 1013 discriminates to which of a plurality of PSS code sequences the detected PSS signal corresponds or does not correspond and outputs the PSS signal to an SSS detection module 1016 as NID2 that is a cell identifier of a physical layer.

The FFT module 1014 executes FFT on the time-axis waveform signal that is the output of the signal reception module 1001. More specifically, the FFT module 1014 cuts out the SSB from the time-axis waveform signal of the baseband after the sampling rate conversion based on the input SSB timing and executes the Fourier transform. Then, the FFT module 1014 outputs a frequency-axis waveform signal of the SSB acquired by the Fourier transform to a waveform equalization module 1015.

The frequency waveform calculation module 1003 includes the waveform equalization module 1015, an SSS detection module 1016, and a DMRS detection module 1017. The frequency waveform calculation module 1003 extracts a part of the frequency-axis waveform signal, which is the output of the FFT module 1014, and calculates a degree of similarity between the extracted signal and a known signal.

The waveform equalization module 1015 corrects at least one of amplitude and phase distortion on an IQ complex plane for the frequency-axis waveform signal. More specifically, the waveform equalization module 1015 corrects at least one of the amplitude and the phase distortion on the IQ complex plane for the frequency-axis waveform signal of the input SSB and outputs a corrected SSB symbol to the SSS detection module 1016 and the DMRS detection module 1017.

The SSS detection module 1016 detects an SSS signal included in the frequency-axis waveform signal. More specifically, the SSS detection module 1016 detects the SSS signal from the frequency-axis waveform signal of the SSB whose waveform has been equalized by the waveform equalization module 1015. The SSS detection module 1016 determines to which of a plurality of SSS sequences the detected SSS signal corresponds or does not correspond. Then, the SSS detection module 1016 outputs NID1 indicating a discriminated group of cell identifiers of a physical layer to the DMRS detection module 1017.

The DMRS detection module 1017 detects a DMRS signal included in the frequency-axis waveform signal. More specifically, the DMRS detection module 1017 detects the DMRS signal from the frequency-axis waveform signal of the SSB subjected to waveform equalization. The DMRS detection module 1017 discriminates to which of a plurality of DMRS sequences the detected DMRS signal corresponds or does not correspond. Then, the DMRS detection module 1017 outputs ibar_SSB corresponding to the DMRS sequence to a switching timing estimation module 1018.

The switching timing estimation module 1018 estimates switching timing between uplink communication and downlink communication in the master station device 10 based on a calculation result of the frequency waveform calculation module 1003. More specifically, the switching timing estimation module 1018 estimates at which position in the transmission period the SSB is arranged from the input ibar_SSB. The switching timing estimation module 1018 estimates DL/UL switching timing in the transmission period from an arrangement position of estimation target SSB and DL/UL configuration information in the known TDD scheme.

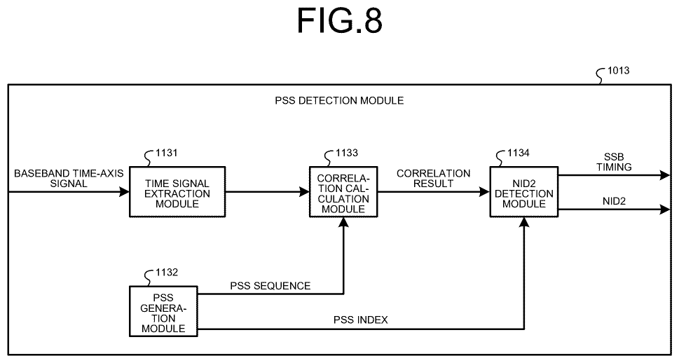

FIG. 8 is a diagram illustrating an example of a functional configuration of the PSS detection module 1013 according to the first embodiment. The PSS detection module 1013 includes a time signal extraction module 1131, a PSS generation module 1132, a correlation calculation module 1133, and a NID2 detection module 1134.

The time signal extraction module 1131 extracts a part of a time-axis waveform signal. More specifically, the time signal extraction module 1131 extracts data having length of an OFDM symbol period from an input baseband time-axis waveform signal and outputs the data to the correlation calculation module 1133. That is, the time signal extraction module 1131 outputs a part of the time-axis waveform signal of the baseband to the correlation calculation module 1133.

The PSS generation module 1132 outputs a plurality of PSS code sequences of a PSS signal and a code sequence number for identifying the PSS code sequence. More specifically, the PSS generation module 1132 outputs a plurality of PSS code sequences to the correlation calculation module 1133 as PSS sequences. Further, the PSS generation module 1132 outputs a PSS index, which is a code sequence number for identifying a PSS code sequence, to the NID2 detection module 1134.

The correlation calculation module 1133 carries out correlation calculation for the time-axis waveform signal, which is the output of the time signal extraction module 1131, and the PSS sequence, which is the PSS code sequence from the PSS generation module 1132, and outputs a correlation value. The correlation calculation module 1133 is an example of a first correlation calculation module. That is, the correlation calculation module 1133 carries out correlation calculation for the baseband time-axis waveform signal input from the time signal extraction module 1131 and the PSS sequence and outputs a correlation value, which is a calculation result, to the NID2 detection module 1134.

The NID2 detection module 1134 outputs, as SSB timing, timing at which the correlation value calculated by the correlation calculation module 1133 is the highest in a predetermined time range and outputs a PSS sequence, which is a PSS code sequence number corresponding to a PSS code sequence having the highest correlation value, as NID2 that is a cell identifier of a physical layer. More specifically, the NID2 detection module 1134 outputs, as SSB timing, timing at which the input correlation value is the highest in predetermined time range. The NID2 detection module 1134 outputs a PSS index corresponding to the PSS sequence having the highest correlation value as NID2 that is the cell identifier of the physical layer.

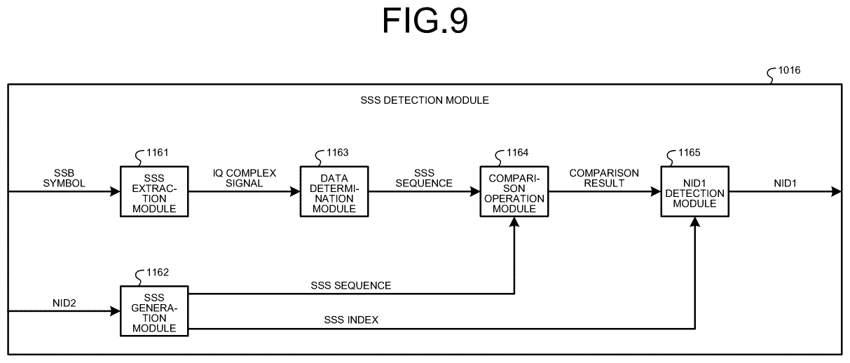

FIG. 9 is a diagram illustrating an example of a functional configuration of the SSS detection module 1016 according to the first embodiment. The SSS detection module 1016 includes an SSS extraction module 1161, an SSS generation module 1162, a data determination module 1163, a comparison operation module 1164, and an NID1 detection module 1165.

The SSS extraction module 1161 extracts a frequency component, in which the SSS signal is arranged, from the frequency-axis waveform signal. More specifically, the SSS extraction module 1161 extracts a frequency component, in which the SSS signal is arranged, from an SSB symbol, which is an input frequency-axis waveform signal after waveform equalization correction, and outputs the extracted frequency component to the data determination module 1163. That is, the SSS extraction module 1161 outputs the frequency component of the SSS signal.

The SSS generation module 1162 outputs a plurality of SSS sequences corresponding to NID2 , which is a cell identifier of a physical layer that is an output of the PSS detection module 1013, and SSS indexes for identifying the SSS sequences. More specifically, the SSS generation module 1162 generates a plurality of SSS code sequences based on the input NID2 and outputs the SSS code sequences to the comparison operation module 1164 as SSS sequences. The SSS generation module 1162 outputs the SSS indexes for identifying the SSS sequences to the NID1 detection module 1165.

The data determination module 1163 determines demodulation data corresponding to an IQ complex coordinate position of the SSS signal, which is the output of the SSS extraction module 1161, and outputs a series of data determined by the entire SSS signal to the comparison operation module 1164 as an SSS sequence. The data determination module 1163 is an example of a first data determination module.

The comparison operation module 1164 compares the SSS sequence from the data determination module 1163 and the SSS sequence from the SSS generation module 1162 and outputs the numbers of matches of values to the NID1 detection module 1165 as comparison results. The comparison operation module 1164 is an example of a first comparison operation module. Note that the comparison operation module 1164 may output, to the NID1 detection module 1165, a similarity degree indicating a degree of similarity between the SSS sequence from the data determination module 1163 and the SSS sequence from the SSS generation module 1162.

The NID1 detection module 1165 determines a comparison result with the highest number of matches out of the comparison results that are outputs of the comparison operation module 1164. Then, the NID1 detection module 1165 outputs an SSS index corresponding to an SSS sequence having the highest number of matches as NID1 indicating a group of cell identifiers of a physical layer. The NID1 detection module 1165 is an example of a first NID1 detection module.

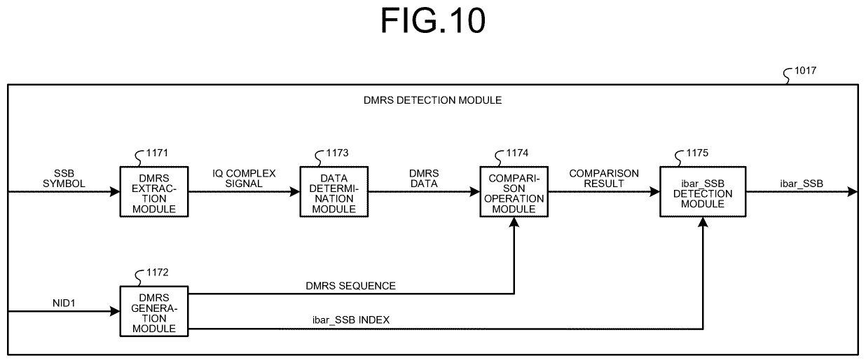

FIG. 10 is a diagram illustrating an example of a functional configuration of the DMRS detection module 1017 according to the first embodiment. The DMRS detection module 1017 includes a DMRS extraction module 1171, a DMRS generation module 1172, a data determination module 1173, a comparison operation module 1174, and an ibar_SSB detection module 1175.

The DMRS extraction module 1171 extracts, from a frequency-axis waveform signal, a frequency component in which a DMRS signal is arranged. More specifically, the DMRS extraction module 1171 extracts a frequency component, in which the DMRS signal is arranged, from an SSB symbol that is an input frequency-axis waveform signal after waveform equalization correction and outputs the extracted frequency component to the data determination module 1173. That is, the DMRS extraction module 1171 outputs the frequency component of the DMRS signal.

The DMRS generation module 1172 outputs a plurality of DMRS sequences corresponding to NID1 indicating a group of cell identifiers of a physical layer, which is an output of SSS detection module 1016, and ibar_SSB indexes for identifying the DMRS sequences. More specifically, the DMRS generation module 1172 generates a plurality of code sequences based on the input NID1 and outputs the code sequences to the comparison operation module 1174 as DMRS sequences. The DMRS generation module 1172 outputs a DMRS index for identifying the DMRS sequences to the ibar_SSB detection module 1175.

The data determination module 1173 determines demodulation data corresponding to an IQ complex coordinate position of the DMRS signal that is the output of the DMRS extraction module 1171 and outputs a series of data determined by the entire DMRS signal to the comparison operation module 1174 as a DMRS sequence. The data determination module 1173 is an example of a second data determination module.

The comparison operation module 1174 compares the DMRS sequence from the data determination module 1173 and the DMRS sequence from the DMRS generation module 1172 and outputs the numbers of matches of values to the ibar_SSB detection module 1175 as comparison results. The comparison operation module 1174 is an example of a third comparison operation module.

The ibar_SSB detection module 1175 determines a comparison result with the highest number of matches out of the comparison results that are outputs of the comparison operation module 1174. Then, the ibar_SSB detection module 1175 outputs an ibar_SSB index corresponding to a DMRS sequence having the highest number of matches as ibar_SSB. The ibar_SSB detection module 1175 is an example of a first ibar_SSB detection module.

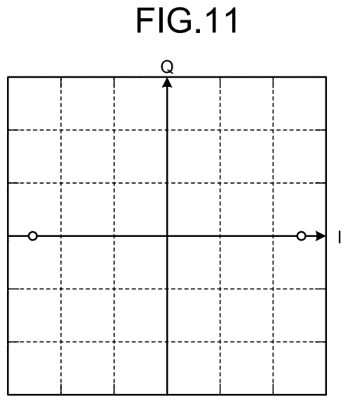

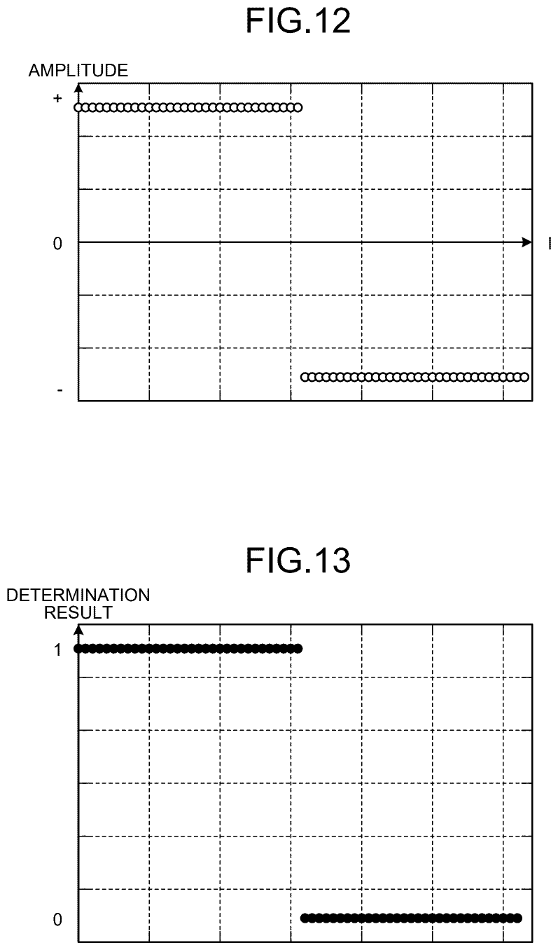

In the configuration explained abo e, demodulation of an SSB symbol by the switching timing generation module 153 is explained using an SSB symbol subjected to binary phase shift keying (BPSK) as an example. FIG. 11 is a diagram illustrating an example of a constellation in the case in which phase rotation is absent. FIG. 12 is a diagram illustrating an example of an I-axis signal in the case in which phase rotation is absent. FIG. 13 is a diagram illustrating an example of a data determination result in the case in which phase rotation is absent.

A case in which the signals illustrated in FIG. 11 and FIG. 12 are input to the data determination module 1163 of the SSS detection module 1016 illustrated in FIG. 9 is explained. As a data determination method, for example, when an I-axis signal has a positive value, determination is made as “1” and, when the I-axis signal has a negative value, determination is made as “0”. In this case, the data determination module 1163 outputs a determination result illustrated in FIG. 13. The determination result illustrated in FIG. 13 is proper as a demodulation result of a BPSK signal.

Thus, when the SSS sequence from the data determination module 1163 and the SSS sequence from the SSS generation module 1162 are the same, the comparison operation module 1164 outputs a comparison result having the highest number of matches. Then, the NID1 detection module 1165 outputs an SSS index corresponding to an SSS sequence at that time as NID1.

The DMRS detection module 1017 detects ibar_SSB using the NID1 . Then, the switching timing estimation module 1018 estimates DL/UL switching timing with ibar_SSB detected by the DMRS detection module 1017.

Note that, although the processing in the SSS detection module 1016 in which the SSB symbol is BPSK is explained above, the processing in the DMRS detection module 1017 in which the SSB symbol is subjected to quadrature phase shift keying (QPSK) can also be explained synonymously with the case of BPSK without loss of generality only by extending the modulation scheme from BPSK to QPSK. Therefore, the detailed description in the DMRS detection module 1017 is omitted here.

Subsequently, various kinds of processing executed by the master station device 10 according to the first embodiment is explained.

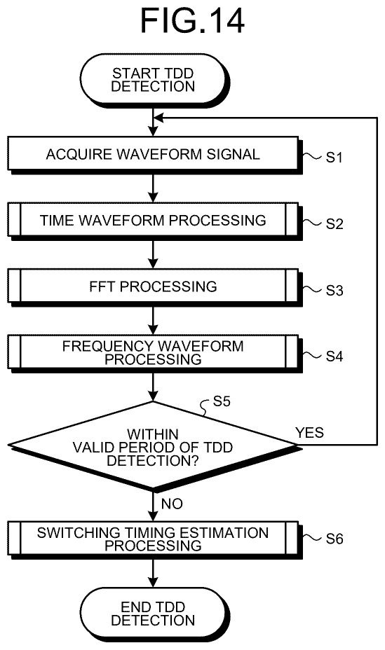

FIG. 14 is a flowchart illustrating an example of TDD detection processing in the first embodiment.

Here, it is assumed that the distributed antenna system 1 is receiving an analog radio signal of either a DL signal or a UL signal. It is assumed that the distributed antenna system 1 is capable of referring to identification information indicating validity/invalidity of a TDD detection processing period and DL/UL configuration information of TDD.

The signal reception module 1001 performs AD conversion, frequency down conversion, and sampling rate conversion from the input analog signal to acquire a time-axis waveform signal of a baseband (Step S1).

Subsequently, the time waveform calculation module 1002 detects a PSS signal arranged at the beginning of SSB from the baseband signal and notifies the FFT module 1014 of timing when the PSS signal is detected as SSB timing (Step S2).

Subsequently, the FFT module 1014 cuts out the SSB from the baseband signal based on the SSB timing notification of which is provided, carries out Fourier transform, and notifies the frequency waveform calculation module 1003 of completion of FFT processing (Step S3).

Subsequently, the frequency waveform calculation module 1003 detects an index number of the SSB indicating at which position in a transmission period the SSB is arranged or not arranged (Step S4).

The signal reception module 1001, the time waveform calculation module 1002, the FFT module 1014, and the frequency waveform calculation module 1003 repeatedly execute Steps SI to S4 explained above during a period in which the TDD detection processing is valid (Step S5).

When the TDD detection processing period ends, the switching timing estimation module 1018 estimates at which position in the transmission period the SSB is arranged and estimates DL/UL switching timing in the transmission period from the arrangement position of the SSB and the known DL/UL configuration information of TDD (Step S6).

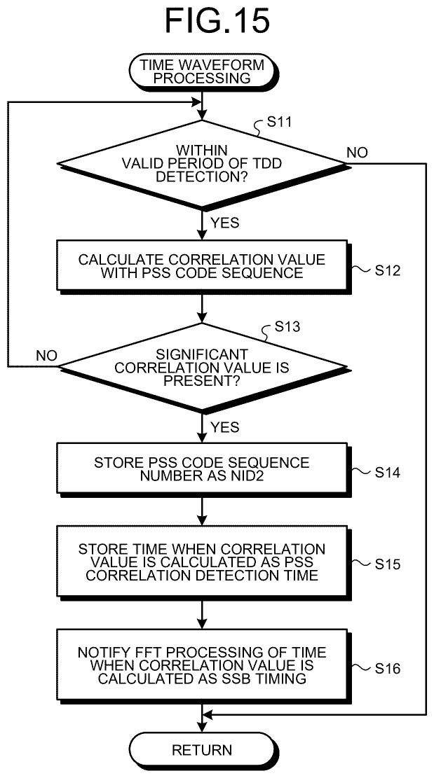

FIG. 15 is a flowchart illustrating an example of time waveform processing according to the first embodiment. That is, the flowchart illustrated in FIG. 15 is the time waveform processing in Step S2.

The time signal extraction module 1131 determines whether a TDD detection processing period is valid (Step S11). When the TDD detection processing period is invalid (Step S11; No), the time signal extraction module 1131 ends time waveform processing. On the other hand, when the TDD detection processing period is valid (Step S11; Yes), the time waveform calculation module 1002 executes the following processing.

Subsequently, the correlation calculation module 1133 calculates a correlation value by executing correlation calculation between a time-axis waveform signal of a baseband and a plurality of PSS code sequences (Step S12).

Subsequently, the NID2 detection module 1134 determines whether a significant correlation value is present among the plurality of correlation calculations (Step S13). Here, a correlation value determined as significant is considered to be a correlation value exceeding a predetermined threshold or a correlation value that is maximized from the start of the time waveform processing to the present. When a significant correlation value is absent (Step S13; No), the NID2 detection module 1134 returns to Step S11. On the other hand, when a significant correlation value is present (Step S13; Yes), the NID2 detection module 1134 executes the following processing.

The NID2 detection module 1134 stores, as NID2 , a PSS sequence that is a PSS code sequence number corresponding to the significant correlation value (Step S14).

The NID2 detection module 1134 stores, as a PSS correlation detection time, system time when the significant correlation value is calculated (Step S15).

The NID2 detection module 1134 notifies the FFT processing illustrated in Step S3 of the system time when the significant correlation value is calculated as SSB timing (Step S16).

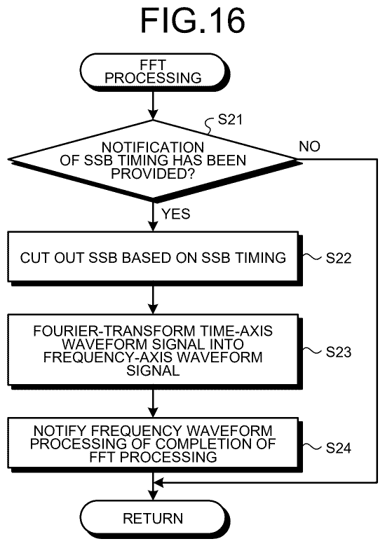

FIG. 16 is a flowchart illustrating an example of FFT processing according to the first embodiment. That is, the flowchart illustrated in FIG. 16 is the FFT processing in Step S3.

The FFT module 1014 determines whether notification of the SSB timing has been provided (Step S21). When the notification of the SSB timing has not been provided (Step S21; No), the FFT module 1014 ends the FFT processing. On the other hand, when the notification of the SSB timing has been provided (Step S21; Yes), the FFT module 1014 executes the following processing.

The FFT module 1014 cuts out SSB from a baseband signal after the sampling rate conversion based on the SSB timing notification of which is provided (Step S22).

The FFT module 1014 executes the Fourier transform to convert a time-axis waveform signal of the cut out SSB into a frequency-axis waveform signal (Step S23).

The FFT module 1014 notifies the frequency waveform processing illustrated in Step S4 of completion of the FFT processing (Step S24).

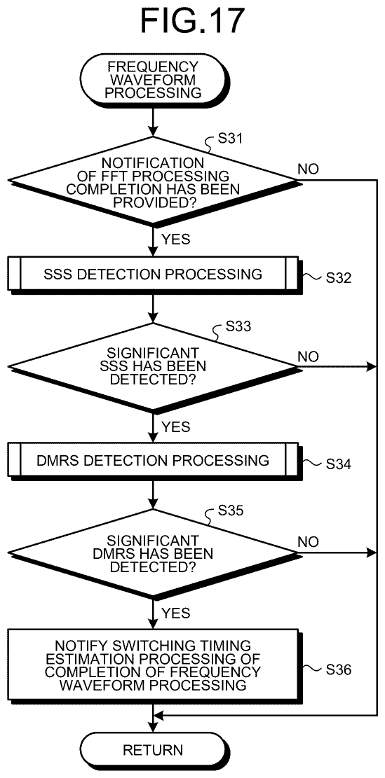

FIG. 17 is a flowchart illustrating an example of frequency waveform processing according to the first embodiment. That is, the flowchart illustrated in FIG. 17 is the frequency waveform processing in Step S4.

The frequency waveform calculation module 1003 determines whether notification of the FFT processing completion has been provided (Step S31). When the notification of the FFT processing completion has not been provided (Step S31; No), the frequency waveform calculation module 1003 ends the frequency waveform processing. On the other hand, when the notification of the FFT processing completion has been provided (Step S31; Yes), the frequency waveform calculation module 1003 executes the following processing.

Subsequently, the SSS detection module 1016 executes SSS detection processing (Step S32).

Subsequently, the frequency waveform calculation module 1003 determines whether significant SSS has been detected (Step S33). Here, SSS determined as significant is, for example, SSS similarity to the SSS sequence calculated in the SSS detection processing exceeds a default threshold and is maximum. When significant SSS is absent (Step S33; No), the frequency waveform calculation module 1003 ends the frequency waveform processing. On the other hand, when significant SSS is present (Step S33; Yes), the frequency waveform calculation module 1003 executes subsequent processing.

Subsequently, the DMRS detection module 1017 executes DMRS detection processing (Step S34).

Subsequently, the frequency waveform calculation module 1003 determines whether significant DMRS has been detected (Step S35). Here, DMRS determined as significant is, for example, DMRS having similarity to the DMRS sequence calculated in the DMRS detection processing exceeds a default threshold and is maximum. If significant DMRS is absent (Step S35; No), the frequency waveform calculation module 1003 ends the frequency waveform processing. On the other hand, when significant DMRS is present (Step S35; Yes), the frequency waveform calculation module 1003 executes the following processing.

Subsequently, the frequency waveform calculation module 1003 notifies the switching timing estimation processing illustrated in Step S6 of completion of the frequency waveform processing (Step S36).

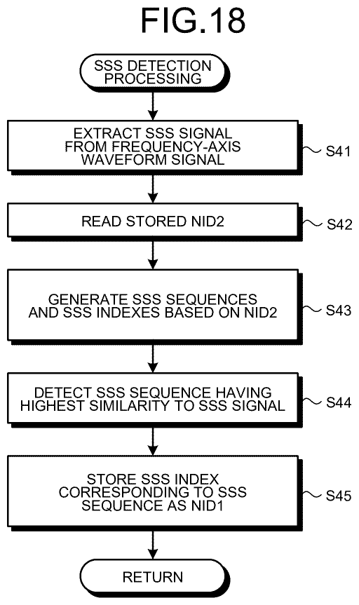

FIG. 18 is a flowchart illustrating an example of SSS detection processing according to the first embodiment. That is, the flowchart illustrated in FIG. 18 is the SSS detection processing in Step S32.

The SSS extraction module 1161 extracts, from the frequency-axis waveform signal, a frequency component in which an SSS signal is arranged (Step S41).

Subsequently, the SSS generation module 1162 reads the NID2 stored in Step S14 (Step S42).

Subsequently, the SSS generation module 1162 generates, based on the NID2 , a plurality of SSS sequences and SSS indexes for identifying the SSS sequences (Step S43).

Subsequently, the comparison operation module 1164 detects an SSS sequence having the highest similarity to the extracted SSS signal (Step S44).

Subsequently, the NID1 detection module 1165 stores an SSS index corresponding to an SSS sequence having the highest similarity as NID1 (Step S45).

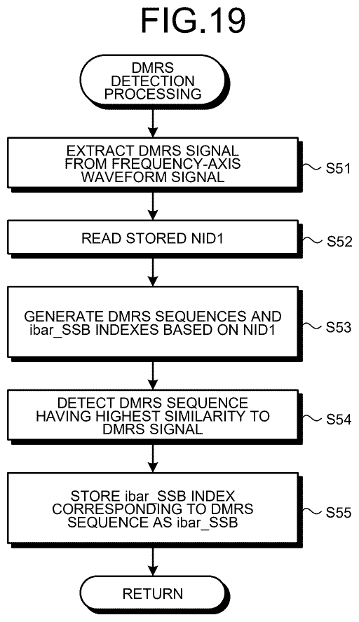

FIG. 19 is a flowchart illustrating an example of DMRS detection processing according to the first embodiment. That is, the flowchart illustrated in FIG. 19 is the DMRS detection processing in Step S34.

The DMRS extraction module 1171 extracts, from a frequency-axis waveform signal, a frequency component in which a DMRS signal is arranged (Step S51).

Subsequently, the DMRS generation module 1172 reads the NID1 stored in Step S45 (Step S52).

Subsequently, the DMRS generation module 1172 generates a plurality of DMRS sequences and ibar_SSB indexes for identifying the DMRS sequences based on the NID1 (Step S53).

Subsequently, the comparison operation module 1174 detects a DMRS sequence having the highest similarity to the extracted DMRS signal (Step S54).

Subsequently, the ibar_SSB detection module 1175 stores an ibar_SSB index corresponding to the DMRS sequence having the highest similarity as ibar_SSB (Step S55).

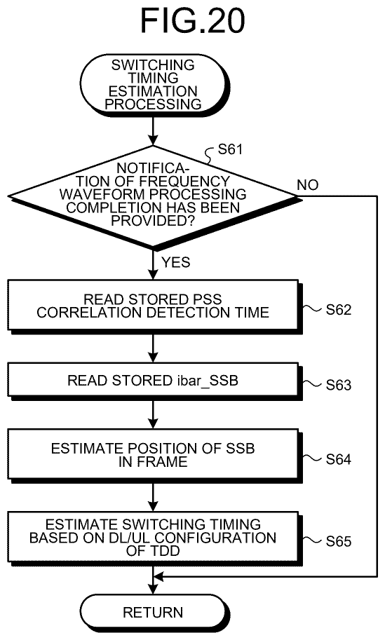

FIG. 20 is a flowchart illustrating an example of switching timing estimation processing according to the first embodiment. That is, the flowchart illustrated in FIG. 20 is the switching timing estimation processing in Step S6.

The switching timing estimation module 1018 determines whether notification of completion of the frequency waveform processing has been provided (Step S61). When the notification of the completion of the frequency waveform processing has not been provided (Step S61; No), the switching timing estimation module 1018 ends the switching timing estimation processing. On the other hand, when the notification of the completion of the frequency waveform processing has been provided (Step S61; Yes), the switching timing estimation module 1018 executes the following processing.

Subsequently, the switching timing estimation module 1018 reads the PSS correlation detection time stored in Step S15 (Step S62).

Subsequently, the switching timing estimation module 1018 reads the ibar_SSB stored in Step S55 (Step S63).

Subsequently, the switching timing estimation module 1018 estimates, from a known SSB arrangement pattern and the ibar_SSB read in Step S63, a position of a frame in which the currently detected SSB is arranged (Step S64).

Subsequently, the switching timing estimation module 1018 estimates, from known TDD DL/UL configuration information, the PSS correlation detection time read in Step S62, and the position of the frame of the SSB estimated in Step S64, timing when TDD switching occurs next (Step S65).

As explained above, the switching timing generation module 153 according to the first embodiment receives the OFDM signal and converts the OFDM signal into the time-axis waveform signal of the baseband. The switching timing generation module 153 extracts a part of the time-axis waveform signal and calculates a correlation value between the extracted signal and a known signal. The switching timing generation module 153 generates a frequency-axis waveform signal by performing FFT on the time-axis waveform signal. The switching timing generation module 153 extracts a part of the frequency-axis waveform signal and calculates a degree of similarity between the extracted signal and the known signal. The switching timing generation module 153 estimates switching timing between uplink communication and downlink communication in the master station device 10 based on a calculation result of the frequency waveform calculation module 1003.

In this manner, the switching timing generation module 153 generates the frequency-axis waveform signal from the time-axis waveform signal and detects the ibar_SSB from the frequency-axis waveform signal. That is, the switching timing generation module 153 grasps at which position in the radio frame the received SSB is arranged. Therefore, in the TDD scheme in which the DL communication and the UL communication are switched in every predetermined period, switching timing generation module 153 can detect DL/UL switching timing even when electric power (a signal) is absent in a first symbol of a radio frame.

### First Modification

Subsequently, a case in which a phase error is added in common (CPE: Common Phase Error) to all subcarriers is conceived. The CPE is an error in which a low-frequency component of a phase error caused by phase fluctuation of a sine wave generated in a local oscillator is dominant. Then, in a wireless communication scheme using OFDM transmission, in general, fluctuation amounts of amplitude or a phase in a propagation path are estimated using a pilot signal inserted into an OFDM symbol and the CPE is corrected by waveform equalization processing.

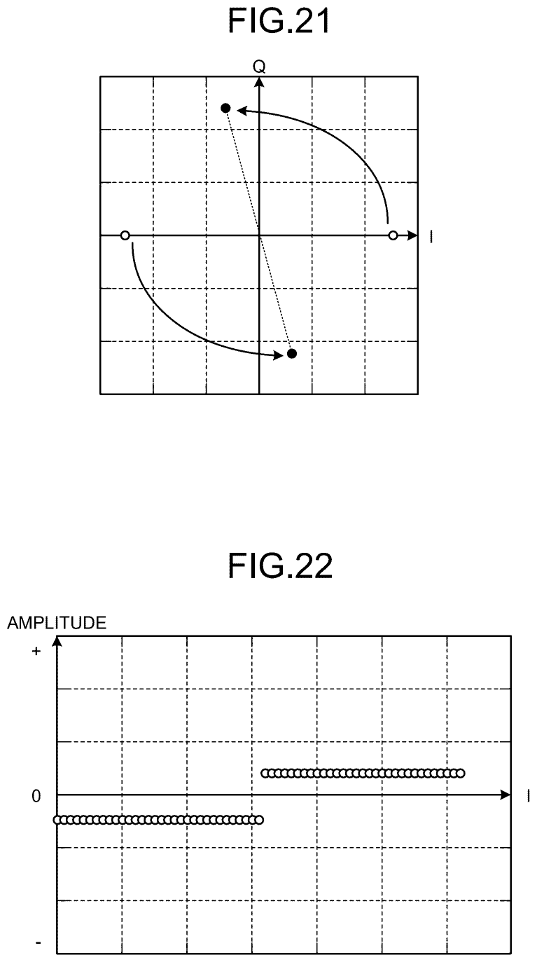

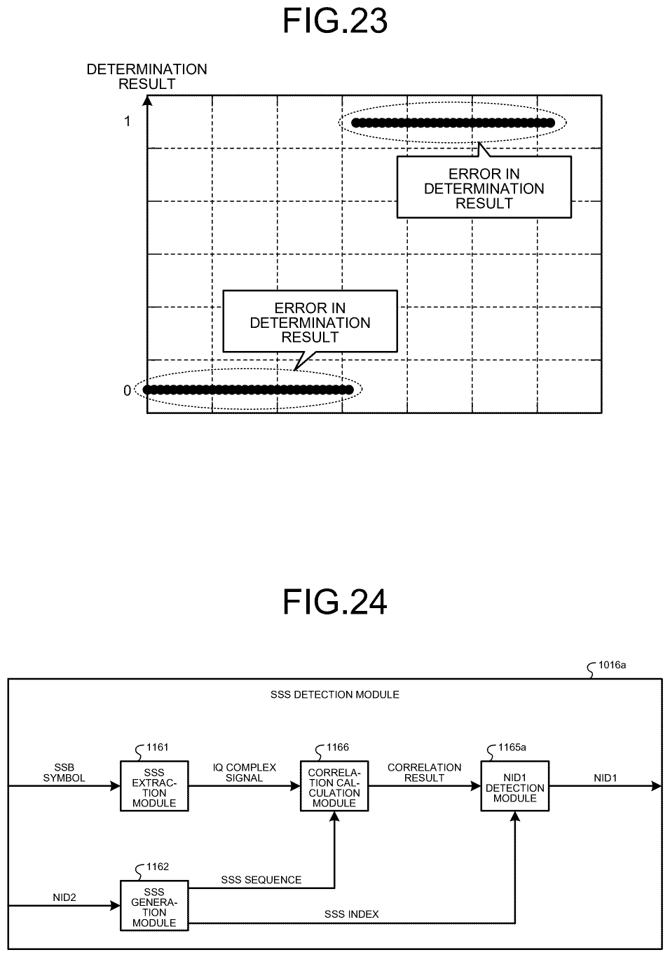

FIG. 21 is a diagram illustrating an example of a constellation in the case in which a CPE is present. FIG. 22 is a diagram illustrating an example of an I-axis signal in the case in which a CPE is present. FIG. 23 is a diagram illustrating an example of a data determination result in the case in which a CPE is present.

A transmission signal is the same as that at the time when the phase rotation is absent explained above. However, a signal in which a CPE remains is input to the data determination module 1163 of the SSS detection module 1016 illustrated in FIG. 9 according to the performance of synchronization processing and waveform equalization processing. When the data determination method is the same as the method explained above of making determination as “1” when the I-axis signal has a positive value and making determination as “0” when the I-axis signal has a negative value, a determination result is as illustrated in FIG. 23. Since positive and negative signs of the I-axis signal are all inverted for the transmission signal, all data determinations are erroneously performed. As a result, the number of matches between the SSS sequence from the data determination module 1163 and the SSS sequence from the SSS generation module 1162 is low, and the detection accuracy in the NID1 detection module 1165 is low.

Therefore, as a first modification, an SSS detection module and a DMRS detection module to which CPE countermeasures are applied are explained with reference to the drawings.

FIG. 24 is a diagram illustrating an example of a functional configuration of an SSS detection module 1016a according to the first modification. Here, components having the same functions as those in FIG. 9 are denoted by the same reference numerals and signs and explanation of the components is omitted. Only components having different functions are explained.

A correlation calculation module 1166 executes a correlation calculation for an IQ complex signal of an SSS signal, which is an output of the SSS extraction module 1161, and an SSS sequence from the SSS generation module 1162. The correlation calculation module 1166 is an example of a second correlation calculation module. More specifically, an SSS signal is input to the correlation calculation module 1166 from the SSS extraction module 1161 and an SSS sequence is input to the correlation calculation module 1166 from the SSS generation module 1162. The correlation calculation module 1166 executes a correlation calculation for an IQ complex signal of the SSS signal and the SSS sequence. Then, the correlation calculation module 1166 outputs a correlation value, which is a result of the correlation calculation, to an NID1 detection module 1165a.

The NID1 detection module 1165a determines a correlation result having the highest correlation value out of correlation results, which are outputs of the correlation calculation module 1166, and outputs an SSS index corresponding to an SSS sequence having the highest correlation value as NID1 indicating a group of cell identifiers of a physical layer. The NID1 detection module 1165a is an example of a second NID1 detection module. More specifically, the NID1 detection module 1165a determines a correlation result having the highest correlation value out of correlation results, which are outputs from the correlation calculation module 1166. Then, the NID1 detection module 1165a outputs an SSS index corresponding to the SSS sequence having the highest correlation value as the NID1 indicating the group of the cell identifiers of the physical layer.

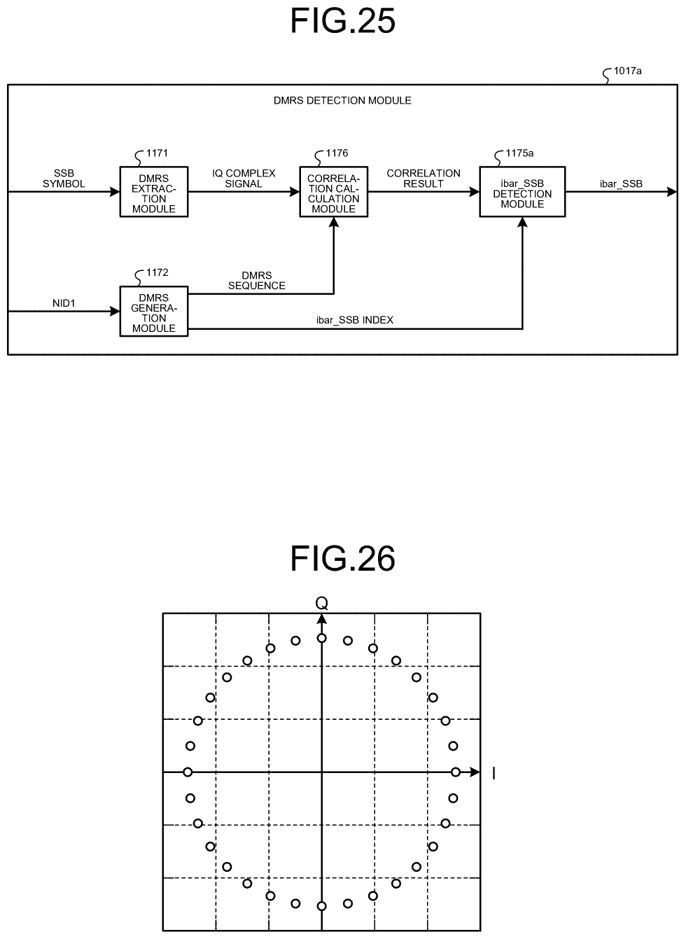

FIG. 25 is a diagram illustrating an example of a functional configuration of a DMRS detection module 1017a according to the first modification. Here, components having the same functions as those in FIG. 10 are denoted by the same reference numerals and signs and explanation of the components is omitted and explanation of the components is omitted. Only components having different functions are explained.

A correlation calculation module 1176 executes a correlation calculation for an IQ complex signal of a DMRS signal, which is an output of the DMRS extraction module 1171, and a DMRS sequence from the DMRS generation module 1172. The correlation calculation module 1176 is an example of a third correlation calculation module. More specifically, a DMRS signal is input to the correlation calculation module 1176 from the DMRS extraction module 1171 and a DMRS sequence is input to the correlation calculation module 1176 from the DMRS generation module 1172. The correlation calculation module 1176 performs a correlation calculation for the DMRS signal and the DMRS sequence. Then, the correlation calculation module 1176 outputs a correlation value, which is a result of the correlation calculation, to an ibar_SSB detection module 1175a.

The ibar_SSB detection module 1175a determines a correlation result having the highest correlation value out of correlation results, which are outputs of the correlation calculation module 1176. Then, the ibar_SSB detection module 1175a outputs an ibar_SSB index corresponding to a DMRS sequence having the highest correlation value as ibar_SSB. The ibar_SSB detection module 1175a is an example of a second ibar_SSB detection module.

As explained above, when a CPE is present, by using the correlation calculation by the correlation calculation modules 1166 and 1176 illustrated in FIG. 24 and FIG. 25 rather than the simple data determination according to the positive and negative signs by the data determination modules 1163 and 1173 and the comparison operation modules 1164 and 1174 illustrated in FIG. 9 and FIG. 10, the similarity between the IQ complex signal and the known data can be accurately calculated even when the CPE is present.

As explained above, the switching timing generation module 153 according to the first modification executes the correlation calculation for the IQ complex signal of the SSS signal and the SSS sequence. Then, the switching timing generation module 153 outputs the SSS index corresponding to the SSS sequence having the highest correlation value as the NID1 . Thus, even when a CPE is present, the switching timing generation module 153 can detect DL/UL switching timing.

### Second Embodiment

Subsequently, a case in which phase rotation is present is conceived.

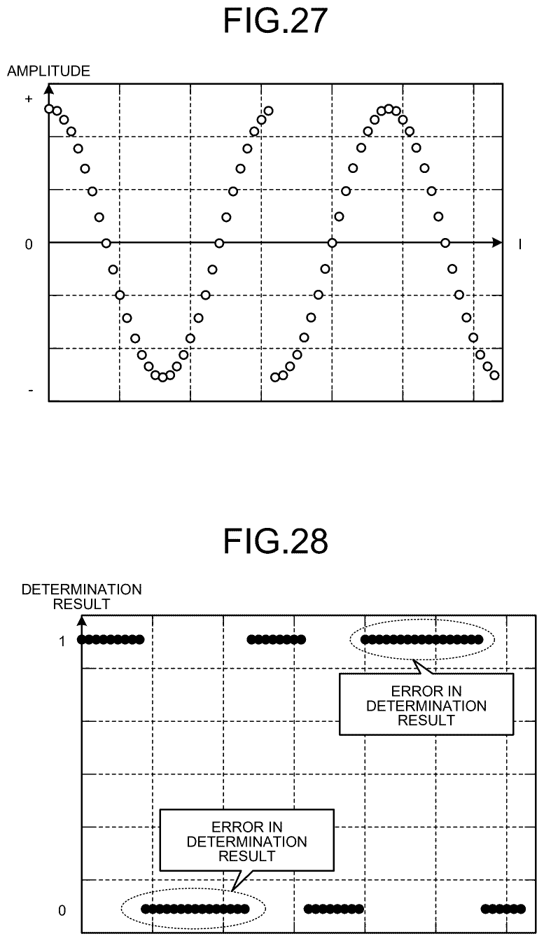

FIG. 26 is a diagram illustrating an example of a constellation in the case in which phase rotation is present. FIG. 27 is a diagram illustrating an example of an I-axis signal in the case in which phase rotation is present. FIG. 28 is a diagram illustrating an example of a data determination result in the case in which phase rotation is present.

When a transmission signal is the same when phase rotation is absent explained above but the performance of the synchronization processing and the waveform equalization processing is not sufficient, a signal in which the phase rotation remains is input to the data determination module 1163 of the SSS detection module 1016 illustrated in FIG. 9. When a data determination method is the same as the method explained above of making determination as “1” when the I-axis signal has a positive value and making determination as “0” when the I-axis signal has a negative value, a determination result is as illustrated in FIG. 28. As is clear from comparison with FIG. 13, there is an error in a wide range of a determination result of a BPSK signal.

Even when the correlation calculation is used as illustrated in FIG. 24, when the IQ complex signal has phase rotation, the correlation value in the correlation calculation module 1166 is suppressed by the rotation component. Therefore, detection accuracy in the NID1 detection module 1165a is deteriorated. As described above, it is difficult to determine the BPSK signal when the IQ complex signal has the phase rotation. Therefore, it is necessary to correct the phase rotation on the IQ complex plane at a stage before the data is determined. For that purpose, it is necessary to perform waveform equalization processing for precisely synchronizing a frequency and a phase of sampling, a frequency and a phase of a carrier wave, symbol timing, and the like and, at the same time, accurately estimating characteristics of a propagation path and correct the influence of the characteristics.

Processing becomes complicated to accurately execute the synchronization processing and the waveform equalization processing, and implementation of the device requires cost. Further, there is a constraint on a time from reception of a signal to completion of demodulation processing of SSB because of a switching time regulation for transmission and reception by the time division multiplexing scheme. Since the synchronization processing and the waveform equalization processing explained above are also subject to this time constraint, as a result, in order to correct the phase rotation, processing circuits for demodulation, synchronization, and waveform equalization need to operate at high speed, and cost for implementing the device becomes higher.

On the other hand, a reception environment of the distributed antenna system 1 is more stable compared with a reception environment of a general mobile phone, and the quality of a reception signal is also satisfactory. It is unnecessary to demodulate all transmitted data and only data necessary for switching of transmission and reception has to be able to be demodulated. For this reason, there is a potential demand for avoiding high costs for the synchronization processing and the waveform equalization processing.

Thus, the master station device 10 according to the second embodiment is subjected to phase rotation countermeasures.

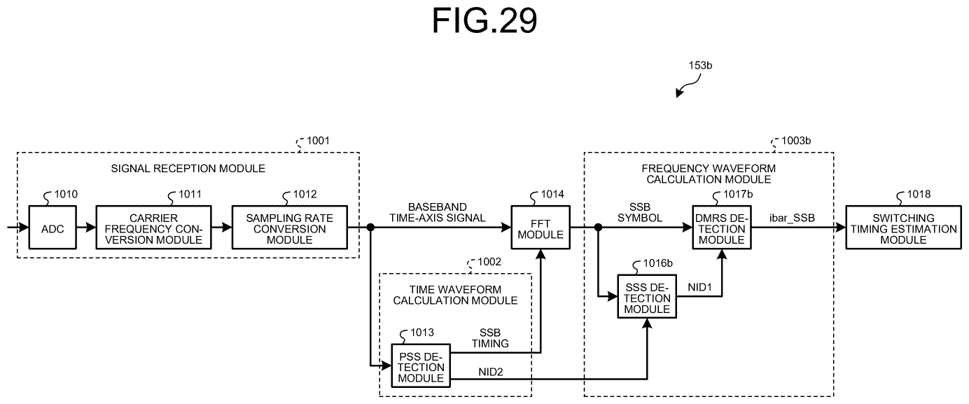

FIG. 29 is a diagram illustrating an example of a

functional configuration of a switching timing generation module 153b in the second embodiment. Here, components having the same functions as those in FIG. 7 are denoted by the same reference numerals and signs and explanation of the components is omitted. Only components having different functions are explained.

In FIG. 7, the output of the FFT module 1014 is input to the waveform equalization module 1015. However, the waveform equalization module 1015 of the frequency waveform calculation module 1003 illustrated in FIG. 7 is absent inf a frequency waveform calculation module 1003b illustrated in FIG. 29. The output of the FFT module 1014 is directly input to an SSS detection module 1016b and a DMRS detection module 1017b. Thus, while cost for the waveform equalization processing decreases, the SSS detection module 1016b and the DMRS detection module 1017b are more strongly affected by amplitude fluctuation and phase fluctuation in a propagation path.

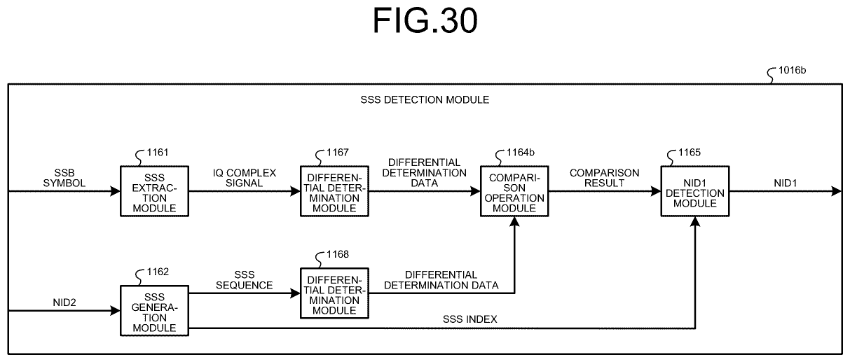

FIG. 30 is a diagram illustrating an example of a functional configuration of the SSS detection module 1016b according to the second embodiment. Here, components having the same functions as those in FIG. 9 are denoted by the same reference numerals and signs and explanation of the components is omitted. Only components having different functions are explained.

A differential determination module 1167 extracts two signals present at a predetermined interval out of IQ complex signals of an SSS signal, which is an output of the SSS extraction module 1161, determines demodulation data corresponding to an IQ complex coordinate position, and outputs differential determination data indicating whether there is a difference between obtained two pieces of demodulation data. The differential determination module 1167 is an example of a first differential determination module. More specifically, the differential determination module 1167 extracts two pieces of demodulation data present at a predetermined interval out of IQ complex signals of an SSS signal input from the SSS extraction module 1161. The differential determination module 1167 determines whether there is a difference between two pieces of demodulation data corresponding to IQ complex coordinate positions. Then, the differential determination module 1167 outputs differential determination data indicating whether there is a difference between the two pieces of demodulation data to a comparison operation module 1164b.

A differential determination module 1168 extracts two signals present at a predetermined interval out of an input SSS sequence. Then, the differential determination module 1168 outputs differential determination data indicating whether there is a difference between two extracted values to the comparison operation module 1164b. The differential determination module 1167 is an example of a second differential determination module.

The comparison operation module 1164b compares the differential determination data from the differential determination module 1167 and the differential determination data from the differential determination module 1168 and outputs the number of matches indicating the number of matched data to the NID1 detection module 1165 as a comparison result. The comparison operation module 1164b is an example of a second comparison operation module.

The NID1 detection module 1165 determines a comparison result having the highest number of matches out of comparison results, which are outputs of the comparison operation module 1164b. Then, the NID1 detection module 1165 outputs an SSS index corresponding to an SSS sequence having the highest number of matches as NID1 indicating a group of cell identifiers of a physical layer. The NID1 detection module 1165 is an example of a third NID1 detection module.

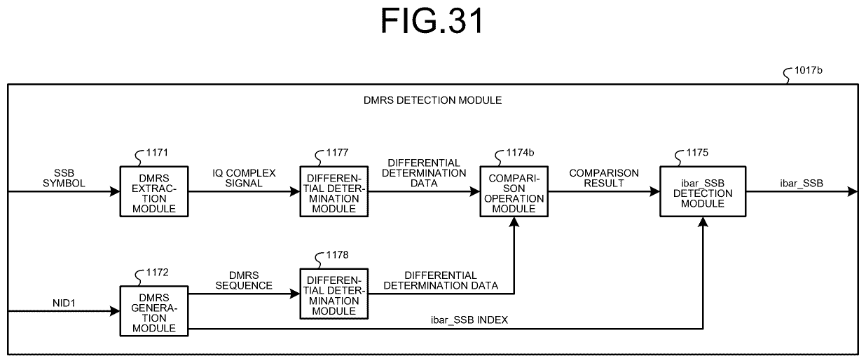

FIG. 31 is a diagram illustrating an example of a functional configuration of a DMRS detection module 1017b according to the second embodiment. Here, components having the same functions as those in FIG. 10 are denoted by the same reference numerals and signs and explanation of the components is omitted. Only components having different functions are explained.

A differential determination module 1177 extracts two signals present at a predetermined interval out of IQ complex signals of a DMRS signal, which is an output of the DMRS extraction module 1171, determines demodulation data corresponding to an IQ complex coordinate position, and outputs differential determination data indicating whether there is a difference between obtained two pieces of demodulation data. The differential determination module 1177 is an example of a third differential determination module. More specifically, the differential determination module 1177 extracts two pieces of demodulation data present at a predetermined interval out of IQ complex signals of the input DMRS signal. The differential determination module 1177 determines whether there is a difference between two pieces of demodulation data corresponding to the IQ complex coordinate position. Then, the differential determination module 1177 outputs differential determination data indicating whether there is a difference between the two pieces of demodulation data to a comparison operation module 1174b.

A differential determination module 1178 extracts two signals present at a predetermined interval from an input DMRS sequence. Then, the differential determination module 1178 outputs differential determination data indicating whether there is a difference between two extracted values to the comparison operation module 1174b. The differential determination module 1178 is an example of a fourth differential determination module.

The comparison operation module 1174b compares the differential determination data from the differential determination module 1177 with the differential determination data from the differential determination module 1178. Then, the comparison operation module 1174b outputs the numbers of matches of the data to the ibar_SSB detection module 1175 as comparison results. The comparison operation module 1174b is an example of a fourth comparison operation module.

The ibar_SSB detection module 1175 determines a comparison result having the highest number of matches out of the comparison results, which are outputs of the comparison operation module 1174b. Then, the ibar_SSB detection module 1175 outputs an ibar_SSB index corresponding to a DMRS sequence having the highest number of matches as ibar_SSB. The ibar_SSB detection module 1175 is an example of a third ibar_SSB detection module.

In such a configuration, demodulation of an SSB symbol in the case in which phase rotation is absent, the case in which a CPE is present, and the case in which phase rotation is present in the master station device 10 according to the second embodiment is explained.

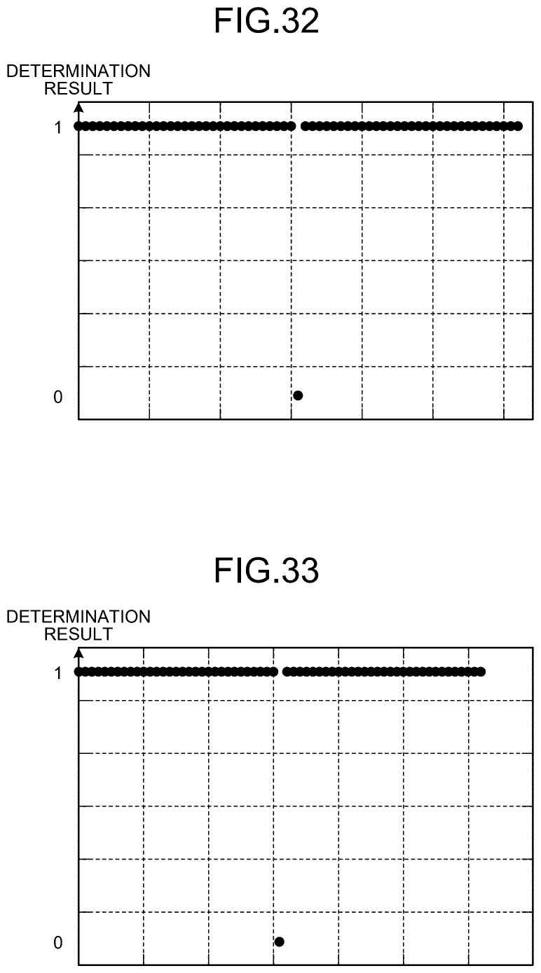

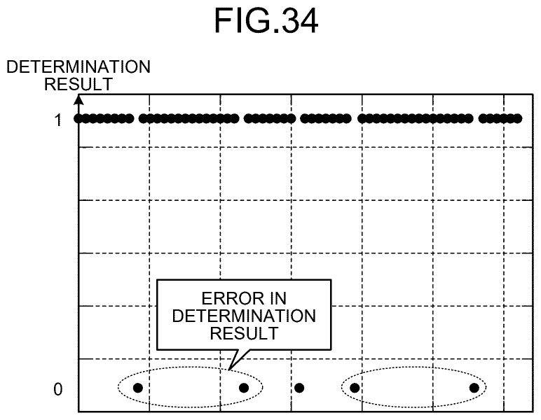

FIG. 32 is a diagram illustrating an example of a differential determination result in the case in which phase rotation is absent. FIG. 33 is a diagram illustrating an example of a differential determination result in the case in which a CPE is present. FIG. 34 is a diagram illustrating an example of a differential determination result in the case in which phase rotation is present.

First, the case in which phase rotation is absent is explained.

As an example of an SSB symbol subjected to binary phase shift keying (BPSK) modulation, a case in which the signals in FIG. 11 and FIG. 12 without phase rotation explained above are input to the differential determination module 1167 of the SSS detection module 1016b in FIG. 30 is explained. As differential determination, for example, focusing on a certain I-axis signal and an I-axis signal adjacent to the certain I-axis signal, when positive and negative signs of both of the signals coincide with each other, determination is made as “1” and, when the positive and negative signs do not coincide with each other, determination is made as “0”. Then, a determination result is as illustrated in FIG. 32. In FIG. 12, the positive and negative signs not coinciding with each other between adjacent two pieces of data is only in a set of data in the vicinity of the center that crosses the I axis. Therefore, in a differential determination result, determination is made as “0” only in the center and determination is made as “1” in other parts. A determination result in the differential determination module 1168 is also the same as the determination result in FIG. 32.

Thus, the comparison operation module 1164b has the highest number of matches when the differential determination data from the differential determination module 1167 and the differential determination data from the differential determination module 1168 are the same. The NID1 detection module 1165 outputs an SSS index corresponding to an SSS sequence at that time as NID1 .

Subsequently, the case in which a CPE is present explained above is explained.

The case of FIG. 21 and FIG. 22 is explained as an example. A transmission signal is the same as that at the time when the phase rotation is absent explained above. However, a signal in which a CPE remains is input to the differential determination module 1167 of the SSS detection module 1016b illustrated in FIG. 30 according to the performance of synchronization processing and waveform equalization processing. As differential determination, when positive and negative signs of a certain I-axis signal and an I-axis signal adjacent thereto coincide with each other between the I-axis signals, determination is made as “1” and, when the positive and negative signs do not coincide with each other, determination is made as “0”. Then, a determination result is as illustrated in FIG. 33. This is the same as the determination result in FIG. 32, and a determination error has not occurred. Thus, it can be seen that the problem due to the CPE is solved not only in the modification of the first embodiment explained above but also in the second embodiment.

Subsequently, the case of FIG. 26 and FIG. 27 in which the phase rotation is present explained above is explained as an example. A transmission signal is the same as that at the time when the phase rotation is absent explained above. However, a signal in which phase rotation remains is input to the differential determination module 1167 of the SSS detection module 1016b illustrated in FIG. 30 according to the performance of synchronization processing and waveform equalization processing. As differential determination, when positive and negative signs of a certain I-axis signal and an I-axis signal adjacent thereto coincide with each other between the I-axis signals, determination is made as “1” and, when the positive and negative signs do not coincide with each other, determination is made as “0”. Then, a determination result is as illustrated in FIG. 34.

In the I-axis signal of FIG. 27, there are five parts that cross an I-axis between two pieces of adjacent data, and positive and negative signs of the two pieces of data are the same at other parts. Therefore, when the differential determination is executed on this signal, determination is made as “0” at the five parts and determination is made as “1” at the other parts. A determination result is as illustrated in FIG. 34. On the other hand, a determination result in the differential determination module 168 is the same as that in FIG. 32 in which phase rotation is absent. Determination is made as “0” at one part and determination is made as “1” at the other parts. Thus, determination result errors occur at four parts. In the first embodiment and the first modification thereof explained above, as illustrated in FIG. 28, errors occur in a wide range of determination results. However, in the second embodiment, a determination error is limited and, as a result, detection accuracy in the NID1 detection module 1165 can be improved.

As explained above, the switching timing generation module 153b according to the first embodiment extracts two signals present at a predetermined interval out of IQ complex signals of an SSS signal and generates differential determination data indicating whether there is a difference between two pieces of demodulation data corresponding to IQ complex coordinate positions. The switching timing generation module 153b extracts two signals at a predetermined interval out of an SSS sequence and generates differential determination data indicating whether there is a difference between extracted two pieces of demodulation data. Then, the switching timing generation module 153b compares the two pieces of differential determination data and outputs an SSS index corresponding to an SSS sequence having the highest number of matches as NID1 . Thus, the switching timing generation module 153b can detect DL/UL switching timing in any of a case in which phase rotation is absent, a case in which a CPE is present, and a case in which phase rotation is present.

A program executed by the master station device 10 in the present embodiment is provided by being recorded in a computer-readable recording medium such as a semiconductor storage device such as a DVD (Digital Versatile Disk), a USB (Universal Serial Bus) memory, an SSD (Solid State Drive) as a file of an installable format or an executable format.

The program may be stored on a computer connected to a network such as the Internet and provided by being downloaded through the network. The program may be provided or distributed through a network such as the Internet.

The program may be provided by being incorporated in a ROM or the like in advance.

1. A communication device that, in a distributed antenna system including a master station device connected to a base station and one or more slave station devices relaying signals between the master station device and one or more terminal devices communicating with the base station, functions as the master station device or the slave station device and receives an OFDM (Orthogonal Frequency Division Multiplexing) signal transmitted in a time division multiplexing scheme, the communication device comprising:
a memory; and
one or more processors coupled to the memory and configured to:
receive the OFDM signal and convert the OFDM signal into a time-axis waveform signal of a baseband;
extract a part of the time-axis waveform signal, and calculate a correlation value between the extracted signal and a known signal;
execute FFT (Fast Fourier Transform) on the time-axis waveform signal;
extract a part of a frequency-axis waveform signal, on which the FFT is executed, and calculate a degree of similarity between the extracted signal and a known signal; and
estimate a switching timing between uplink communication and downlink communication in the communication device based on a calculation result of the similarity degree.

2. The communication device according to claim 1, wherein
the one or more processors are further configured to receive a PSS (Primary Synchronization Signal), an SSS (Secondary Synchronization Signal), and an SSB (SS/PBCH Block) having a PBCH (Physical Broadcast Channel) including a DMRS (DeModulation of Reference Signal).

3. The communication device according to claim 2, wherein
the one or more processors are further configured to detect a PSS signal included in the time-axis waveform signal.

4. The communication device according to claim 3, wherein
the one or more processors are further configured to:
extract a part of the time-axis waveform signal;
output a plurality of PSS code sequences of the PSS signal and code sequence numbers for identifying the PSS code sequences;
carry out a correlation calculation between a time-axis waveform signal and the PSS code sequence, and output a correlation value; and
output, as an SSB timing, a timing when the correlation value is the highest within a predetermined time range, and output, as an NID2 that is a cell identifier of a physical layer, a PSS code sequence number corresponding to the PSS code sequence at which the correlation value is the highest.

5. The communication device according to claim 1, wherein
the one or more processors are further configured to correct at least one of an amplitude and a phase distortion on an IQ complex plane with respect to the frequency-axis waveform signal.

6. The communication device according to claim 3, wherein
the one or more processors are further configured to detect an SSS signal included in the frequency-axis waveform signal.

7. The communication device according to claim 6, wherein
the one or more processors are configured to detect a DMRS signal included in the frequency-axis waveform signal.

8. The communication device according to claim 6, wherein
the one or more processors are further configured to:
extract, from the frequency-axis waveform signal, a frequency component in which the SSS signal is arranged; and
output a plurality of SSS sequences corresponding to an NID2 , which is a cell identifier of a physical layer, and SSS indexes for identifying the SSS sequences.

9. The communication device according to claim 8, wherein
the one or more processors are further configured to:
determine demodulation data corresponding to an IQ complex coordinate position of the SSS signal, and output a series of data determined by an entire of the SSS signal as an SSS sequence;
compare the SSS sequence and the plurality of SSS sequences, and output numbers of matches of values as comparison results; and
determine a comparison result having a highest number of matches out of the comparison results, and output an SSS index corresponding to the SSS sequence having the highest number of matches as an NID1 indicating a group of cell identifiers of a physical layer.

10. The communication device according to claim 8, wherein
the one or more processors are further configured to:
execute a correlation calculation between an IQ complex signal of the SSS signal and the plurality of SSS sequences; and
determine a correlation result having a highest correlation value out of correlation results, and output an SSS index corresponding to the SSS sequence having the highest correlation value as an NID1 indicating a group of cell identifiers of a physical layer.

11. The communication device according to claim 8, wherein
the one or more processors are further configured to:
extract two signals present at a predetermined interval out of IQ complex signals of the SSS signal, determine demodulation data corresponding to an IQ complex coordinate position, and output first differential determination data indicating whether there is a difference between obtained two pieces of demodulation data;
extract two values present at a predetermined interval out of the plurality of SSS sequences, and output second differential determination data indicating whether there is a difference between the extracted two values;
compare the first differential determination data and the second differential determination data, and output numbers of matches of the data as comparison results; and
determine a comparison result having the highest number of matches out of the comparison results, and output an SSS index corresponding to the SSS sequence having the highest number of matches as an NID1 indicating a group of cell identifiers of a physical layer.

12. The communication device according to claim 7, wherein
the one or more processors are further configured to:
extract, from the frequency-axis waveform signal, a frequency component in which a DMRS signal is arranged; and
output a plurality of DMRS sequences corresponding to an NID1 indicating a group of cell identifiers of a physical layer, and ibar_SSB indexes for identifying the DMRS sequences.

13. The communication device according to claim 12, wherein
the one or more processors are further configured to:
determine demodulation data corresponding to an IQ complex coordinate position of the DMRS signal, and output a series of data determined by an entire of the DMRS signal as a DMRS sequence;
compare the DMRS sequence and the plurality of DMRS sequences, and output numbers of matches of values as comparison results; and
determine a comparison result having the highest number of matches out of the comparison results, and output an ibar_SSB index corresponding to the DMRS sequence having the highest number of matches.

14. The communication device according to claim 12, wherein
the one or more processors are further configured to:
execute a correlation calculation between an IQ complex signal of the DMRS signal, and the plurality of DMRS sequences; and
determine a correlation result having a highest correlation value out of correlation results, and output an ibar_SSB index corresponding to the DMRS sequence having the highest correlation value.

15. The communication device according to claim 12, wherein
the one or more processors are further configured to:
extract two signals present at a predetermined interval out of IQ complex signals of the DMRS signal, determine demodulation data corresponding to an IQ complex coordinate position, and output third differential determination data indicating whether there is a difference between obtained two pieces of demodulation data;
extract, out of the plurality of DMRS sequences, two values present at a predetermined interval, and output fourth differential determination data indicating whether there is a difference between the extracted two values;
compare the third differential determination data and the fourth differential determination data, and output numbers of matches of the data as comparison results; and
determine a comparison result having the highest number of matches out of the comparison results, and output an ibar_SSB index corresponding to the DMRS sequence having the highest number of matches.

16. A control method for a communication device that, in a distributed antenna system including a master station device connected to a base station and one or more slave station devices relaying signals between the master station device and one or more terminal devices communicating with the base station, functions as the master station device or the slave station device and receives an OFDM (Orthogonal Frequency Division Multiplexing) signal transmitted in a time division multiplexing scheme, the control method comprising:
receiving the OFDM signal and converting the OFDM signal into a time-axis waveform signal of a baseband;
extracting a part of the time-axis waveform signal and calculating a correlation value between the extracted signal and a known signal;
executing FFT (Fast Fourier Transform) on the time-axis waveform signal;
extracting a part of a frequency-axis waveform signal, on which the FFT is executed, and calculating a degree of similarity between the extracted signal and a known signal; and
estimating a switching timing between uplink communication and downlink communication in the communication device based on a calculation result of the similarity degree.

17. A computer program product comprising a non-transitory computer-readable medium including programmed instructions for a communication device that, in a distributed antenna system including a master station device connected to a base station and one or more slave station devices relaying signals between the master station device and one or more terminal devices communicating with the base station, functions as the master station device or the slave station device and receives an OFDM (Orthogonal Frequency Division Multiplexing) signal transmitted in a time division multiplexing scheme, the instructions causing the communication device to execute:
receiving the OFDM signal and converting the OFDM signal into a time-axis waveform signal of a baseband;
extracting a part of the time-axis waveform signal, and calculating a correlation value between the extracted signal and a known signal;
executing FFT (Fast Fourier Transform) on the time-axis waveform signal;
extracting a part of a frequency-axis waveform signal, on which the FFT is executed, and calculating a degree of similarity between the extracted signal and a known signal; and
estimating a switching timing between uplink communication and downlink communication in the communication device based on a calculation result of the similarity degree.
